(19) United States
(12) Patent Application Publication
(10) Pub. No.: US 2010/0099448 A1
(43) Pub. Date: Apr. 22, 2010

(54) METHOD AND APPARATUS FOR INPUTTING RECEIVER INFORMATION OF TEXT MESSAGE

(75) Inventors: Seung Won YIM, Seoul (KR); Dong Jin LEE, Daegu Metropolitan City (KR); Dong Hwan CHOI, Daegu Metropolitan City (KR); Hye Joon YI, Chungcheongbuk-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/578,651

(22) Filed: Oct. 14, 2009

(30) Foreign Application Priority Data
Oct. 20, 2008 (KR) 10-2008-0102379
Jul. 15, 2009 (KR) 10-2009-0064563

(51) Int. Cl. H04M 1/00; G09G 5/00; H04W 4/00

(52) U.S. Cl. 455/466; 345/156; 455/566

(57) ABSTRACT

A method and apparatus for a portable terminal intuitively and easily inputs receiver information of a text message for use when the portable terminal transmits the text message to others or replies to the text message. The receiver information inputting method includes extracting and displaying a preset number of items, in response to a request to input receiver information; calling receiver information linked to an item that is selected from among the items; and inputting the called receiver information in a receiver information input field.

### CLAIM OF PRIORITY

This application claims the benefit under 35 U.S.C. §119(a) from Korean patent applications filed in the Korean Intellectual Property Office on Oct. 20, 2008 and Jul. 15, 2009 and assigned Serial Nos. 10-2008-0102379 and 10-2009-0064563, respectively, the entire disclosures of which is hereby incorporated by reference in their entirety.

### BACKGROUND OF THE INVENTION

1. Field of the Invention

The present invention relates to text message transmission. More particularly, the present invention relates to a method and apparatus regarding receiving information of a text message in a portable terminal and transmitting the text message based on the received text message.

2. Description of the Related Art

In general, portable terminals, such as mobile phones, having many functions, but to a large degree are often used for making and receiving calls, as well as transmitting and receiving text messages. A text message transmission/reception function allows portable terminals to transmit/receive short/long text messages to/from other portable terminals, without using additional devices. This function is known as a message service, and is becoming more and more popular among users, particularly those of a young age. Examples of the message service are a short message service (SMS), a multimedia messaging service (MMS), email service, etc.

In recent years, the number of portable terminal users who utilize the message service has rapidly increased. The message service can be easily used and allows for rapid transmission of a message, and sometimes save the time that would be necessary with an actual voice call, as societal protocols of politeness can often take several minutes at a minimum when making a voice call, whereas a user can receive or provide certain information with a text in a very short period of time, sometimes in a matter of seconds. This message service can also repeat message transmissions, although portable terminals cannot easily perform such services for a voice call. Due to this advantage, the message service is becoming increasingly popular and serves as communication means following the voice call.

When a text message is intended to be transmitted to at least one receiver, a portable terminal user can set receiver information to make it easier to send such messages, in such a way that the receiver's name or a group name, stored in the phone book, can be directly input on the screen for inputting a receiver's phone number or a receiver is selected via a searching operation.

Most portable terminal users frequently use a particular receiver to send information, for example, a good friend, one's employer, a family member, etc. Every time a portable terminal user intends to send a message to a receiver, he/she must directly input receiver information for a text message or must search for and select a receiver. The aforementioned process of directly inputting receiver information or searching and selecting can inconvenience the portable terminal user. In particular, if the receiver information is input through a searching process, the portable terminal users cannot identify phone numbers, stored in a phone book, or information immediately. That is, they must search for and identify information, piece-by-piece, using direction keys on the keypad, and then must select corresponding information.

Even when a portable terminal user intends to send a text message to a receiver in a recent call history, he/she must input receiver information regarding the receiver or search for the receiver information, piece-by-piece, as described above. These processes cause the portable terminal user to waste a considerable amount of time.

Therefore, there is a long-felt need for a method and a user interface that can intuitively and easily input receiver information of a text message in the portable terminal.

### SUMMARY OF THE INVENTION

The present invention provides a user interface in a portable terminal can intuitively input information regarding a receiver who will receive a text message about to be sent.

The present invention further provides a method and apparatus for a portable terminals that can intuitively and easily input information regarding a receiver, who will receive a text message, when the portable terminal user intends to send the text message to the receiver.

The present invention further provides a method and apparatus that can provide higher ranked information corresponding to a number of information set in the recent call history, and can more easily input information regarding a receiver, who will receive a text message, by selecting the higher ranked information, when the portable terminal user intends to send the text message to the receiver.

The present invention further provides a method and apparatus that can provide a preset number of items when a text message is transmitted, including call receiver information linked to a selected item, and automatically input the called receiver information in a receiver information input field of a portable terminal.

In accordance with an exemplary embodiment of the present invention, the present invention provides a method for inputting receiver information when a text message is transmitted, said method preferably includes: extracting and displaying a preset number of items in response to a request to input receiver information; calling receiver information linked to an item that is selected from among the items; and inputting the called receiver information in a receiver information input field.

In accordance with another exemplary embodiment of the present invention, the present invention also provides a portable terminal that preferable includes: a display unit for displaying a screen according to a text message writing mode and a receiver information input window, when a receiver information input request occurs, wherein the receiver information input window comprises an item display field of a certain number of items and a receiver information input field; a storage unit for storing setting information that is related to input receiver information according to the selection of an item, and a phone book containing at least one phone number previously registered; and a controller for calling receiver information from the phone book that corresponds to an item selected from among a certain number of items in the item display field; and inputting the called receiver information in the receiver information input window.

### BRIEF DESCRIPTION OF THE DRAWINGS

The above and other exemplary aspects, features and advantages of certain exemplary embodiments of the present invention will become more apparent to the person of ordinary skill in the art from the following description taken in conjunction with the accompanying drawing, in which:

FIG. 1 is a flow chart describing an exemplary operational method for transmitting a text message in a portable terminal according to an exemplary embodiment of the present invention;

FIGS. 2A, 2B and 2C are views showing screens that display processes while receiver information is input in a portable terminal via a button keypad, according to an exemplary embodiment of the present invention;

FIGS. 2D and 2E are views showing examples of touch screens that display processes while receiver information is input in a portable terminal by a touch operation, according to an exemplary embodiment of the present invention;

FIG. 3 is a flow chart describing some operational steps of a method for inputting receiver information of a text message in a portable terminal according to an exemplary embodiment of the present invention;

FIG. 4 is a view showing screens that display processes while an item is set, according to an exemplary embodiment of the present invention; and

FIG. 5 is a schematic block diagram illustrating a portable terminal according to an exemplary embodiment of the present invention.

### DETAILED DESCRIPTION

Hereinafter, exemplary embodiments of the present invention are described herein in detail with reference to the accompanying drawings. Detailed descriptions of well-known functions and structures incorporated herein may be omitted to avoid obscuring appreciation by a person of ordinary skill in the art of the subject matter of the present invention with such well-known functions and structures.

In the following description, exemplary embodiments according to a user interface for inputting receiver information of a text message in a portable terminal are explained, and a method and apparatus for inputting the receiver information using the user interface is also explained.

In particular, in an exemplary embodiment of the present invention, items that can directly call receiver information registered in a phone book are provided to a receiver information input window. The “receiver information” refers to information that is previously registered in the phone book, and that may also be registered by a user's settings.

The “item” serves to call receiver information linked to thereto from a phone book and automatically input it to the receiver information input field. The receiver information contains at least one receiver's phone number corresponding to the item, the receiver's email address, etc.

When the portable terminal user selects an item, the portable terminal searches for and calls at least one of the pieces of receiver information linked to the item, and automatically registers the called receiver information in a receiver information input field. The item may be receiver information that the user frequently uses, or information according to a recent call history, which will be determined by the user's preferred setting.

For example, according to an exemplary aspect of the present invention, a text message can be directly transmitted to receiver information corresponding to a user's selected item. To this end, a portable terminal user sets an item extracting method in the portable terminal, which will be explained later. If the item extracting method includes a designation mode that will be described herein after, an item, which will be displayed in the designation mode, can be previously set in the phone book.

According to the particular function of the present invention, a portable terminal can intuitively and easily input receiver information for a user, which he/she frequently uses, or from receiver information according to a recent call history in the portable terminal when he/she transmits a text message.

In an exemplary embodiment of the present invention, a “text message” typically refers to a short or long text message communicated among portable terminals, and is served by a messages service. The message service according to the present invention may be a short message service (SMS), a multimedia messaging service (MMS), an email service, etc. It should be understood that the present invention can be implemented with any other types of message services that can be provided by a portable terminal. In an embodiment of the present invention, receiver information may be a phone number of a called portable terminal, a receiver's e-mail address, etc.

In the following description, user interfaces and screens corresponding to the user interfaces, provided in the portable terminal according to the present invention, are explained in more detail. Operations of the portable terminal are also described in detail. It should be, however, understood that the present invention is not limited to the exemplary embodiments. It will be appreciated by the person of ordinary skill in the art that there are many modifications based on the exemplary embodiments that lie within the spirit of the invention and the scope of the appended claims.

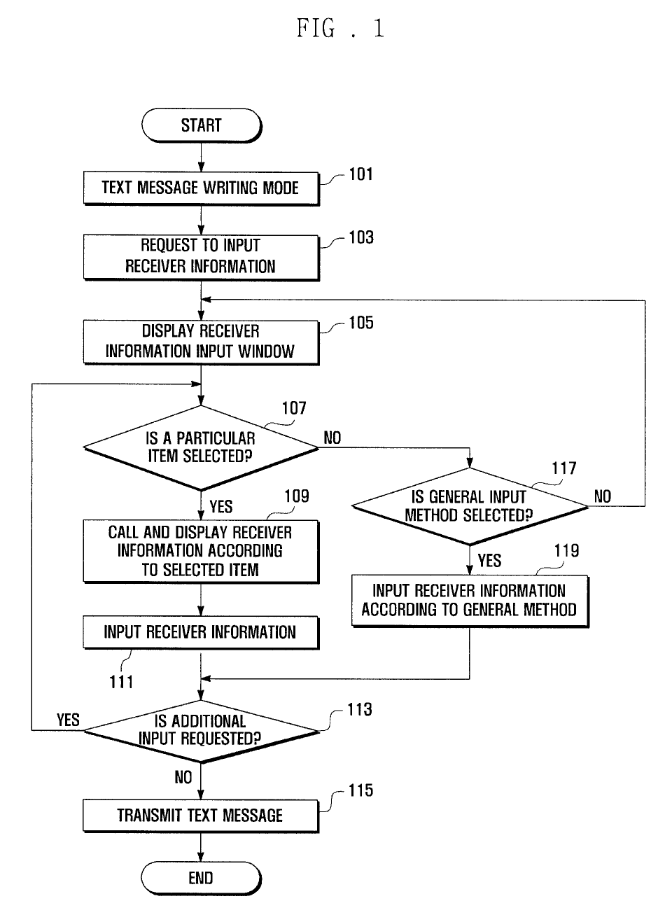

FIG. 1 is a flow chart describing a method for transmitting a text message in a portable terminal according to an embodiment of the present invention.

Referring now to FIG. 1, the portable terminal provides a text message writing mode in response to a user's request (101). In the text message writing mode, the portable terminal user typically writes a text message, such as inputting letters for a text message, attaching a file to a text message, etc. When completing the process of writing the text message, the user inputs information regarding a receiver who will receive the written text message.

When the portable terminal detects a user's request to input receiver information in the text message writing mode (103), the portable terminal provides a receiver information input window that can receive receiver information (105). In an exemplary embodiment of the present invention, the portable terminal can display a certain number of items on the receiver information input window, according to a setting method.

In an exemplary embodiment of the present invention, the item refers to an icon that can call a user's set receiver information from among information stored in a phone book of the portable terminal, and that can display the called receiver information on the receiver information input field. The item can be linked to receiver information from among information stored in the phone book. The item is provided to a position that the user can easily recognize on the receiver information input window, so that the user can intuitively and easily input receiver information by selecting the item. The item will be explained, in detail, with reference to screens, herein after.

Still referring to FIG. 1, after displaying the receiver information input window, the portable terminal determines whether a particular item has been selected from among a certain number of items displayed on the receiver information input window (107). If the portable terminal determines that a particular item has not been selected at 107, the portable terminal then determines whether a general input method has been selected (117). On the contrary, if the portable terminal determines that a particular item has been selected at 107, the portable terminal calls receiver information linked to the selected item from a phone book and displays the receiver information on the receiver information input field (109).

Referring again to step (107) in FIG. 1, the selection refers to a state in which a particular item is highlighted according to a user's input. When a particular item is highlighted, receiver information corresponding to the particular item is preferably displayed on the receiver information input filed. When the highlight is moved to another item, receiver information displayed on the receiver information input field, is also changed and then displayed according to another highlighted item. After that, if the user selects the final input with respect to the receiver information displayed on the receiver information input field, the receiver information corresponding to the highlighted item (the receiver information displayed on the receiver information input field) is finally input. This process will be described, in detail, later, with reference to screens of the display unit.

Next, still referring to FIG. 1, the portable terminal finally inputs the receiver information in the receiver information input field, in response to a final input request for receiver information displayed on the receiver information input field (111).

That is, the receiver information displayed at step 109 corresponds to an item that the user selects before the final input request is input. When the selection for the item is cancelled, and another item is selected, the displayed receiver information is also changed in response to the changed item. On the contrary, the receiver information, input according to the user's final input request, is designated as final input information, so that, although a selection for the item is changed, the receiver information input in the receiver information input field is not changed in a final input request. If a selection for the item is changed, the portable terminal adds a new receiver information input field below the receiver information input field on which the final input receiver information is displayed, so that receiver information corresponding to the changed item can be displayed on the added receiver information input field.

Therefore, in order to distinguish between receiver information that has been finally selected and receiver information that has not been finally selected, the portable terminal may display the receiver information differently such as in a light color, indicating an inactivated state, at step 109, and the final input receiver information in a dark color, indicating an activated state, at step 111. An artisan understands and appreciates there are various types of visual indications that can be used to indicate activated and inactivated states.

Although it is not shown in FIG. 1, when the portable terminal user requests transmission of the written text message in an inactivated state before the final receiver information is input, the portable terminal may transmit the text message to a corresponding portable terminal according to the receiver information.

Next, the portable terminal determines whether an input for additional receiver information is requested (113). If the portable terminal ascertains that an additional receiver information input is requested at 113, it returns to and proceeds with step 107. On the contrary, if the portable terminal ascertains that an additional receiver information input is not requested at 113, and a transmission for the written text message is requested, it transmits the text message to a corresponding portable terminal according to the input receiver information (115).

Meanwhile, if the portable terminal determines that a general input method is selected at 117, it inputs receiver information according to the general input method (119) and then proceeds with step 113. The general input method may be, for example, a method that inputs a user's name or phone book as a cursor is located in the receiver information input field or a method that calls a phone book, searches for corresponding receiver information, and then inputs it. These methods will be explained, in detail, herein after. On the contrary, if the portable terminal ascertains that a general input method is not selected at 117, it returns to and proceeds with step 105.

As described in the above exemplary embodiment of the present invention, receiver information is additionally input after the final receiver information has been input. However, it should be understood that that the present invention is not limited to the aforementioned exemplary embodiment. For example, it may be modified in such a way that, if a particular item is selected and then an additional input for receiver information is requested, the state of the selected item can be changed into the final input state.

In the following description, screens corresponding to the operations of the portable terminal, described above with reference to FIG. 1, are explained in detail.

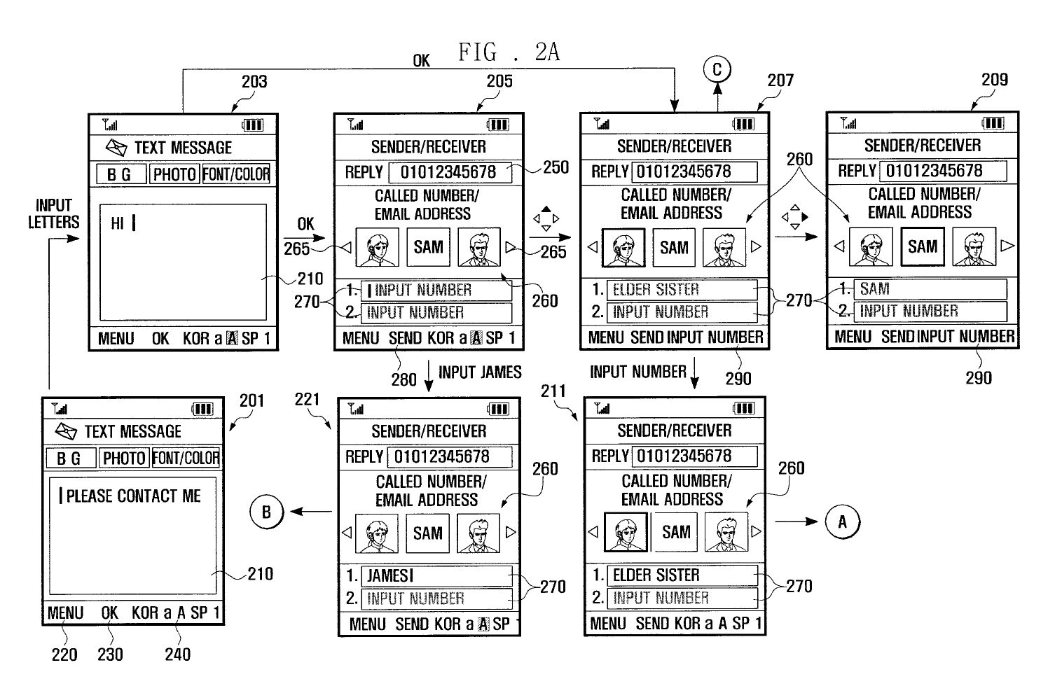

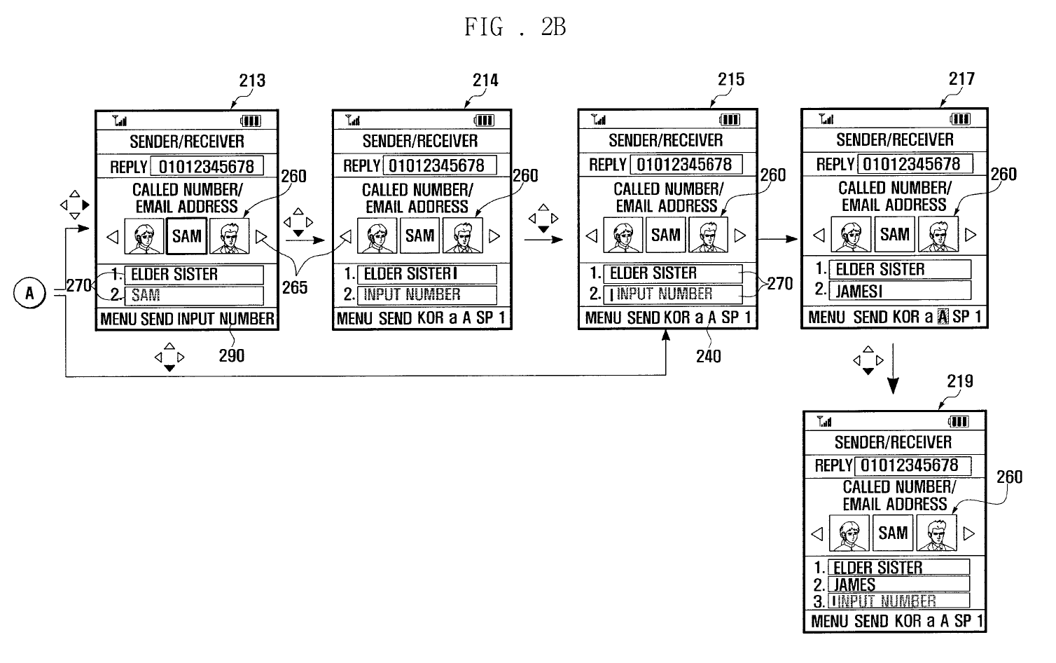

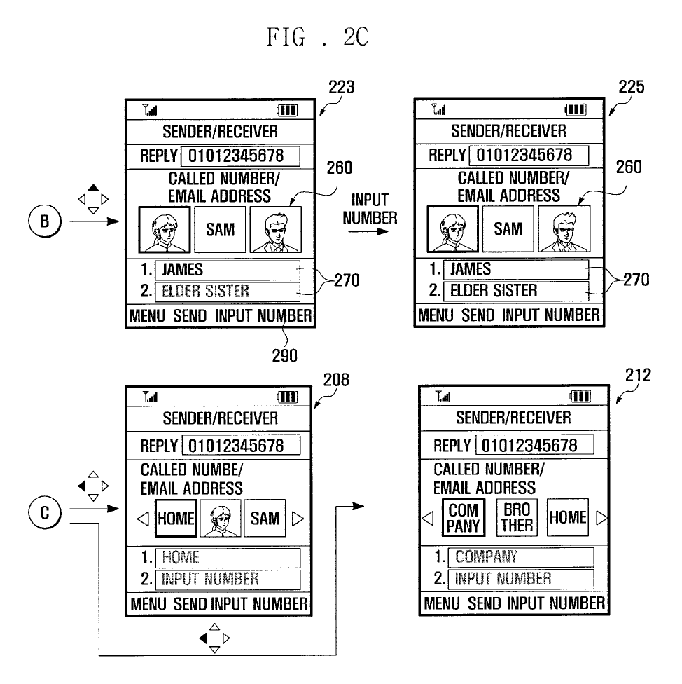

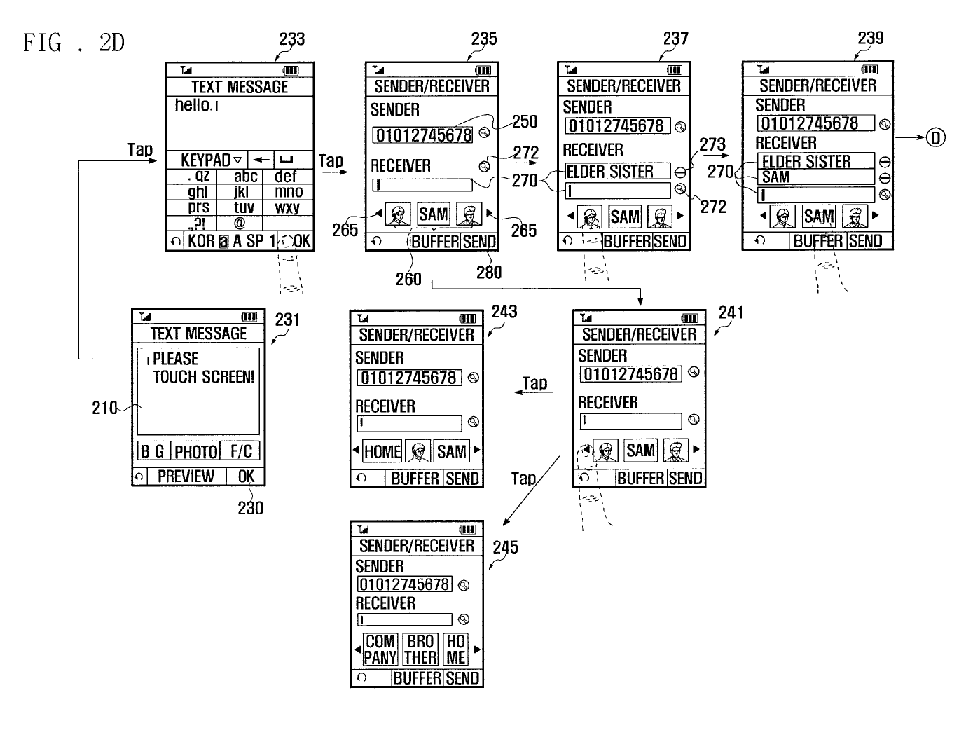

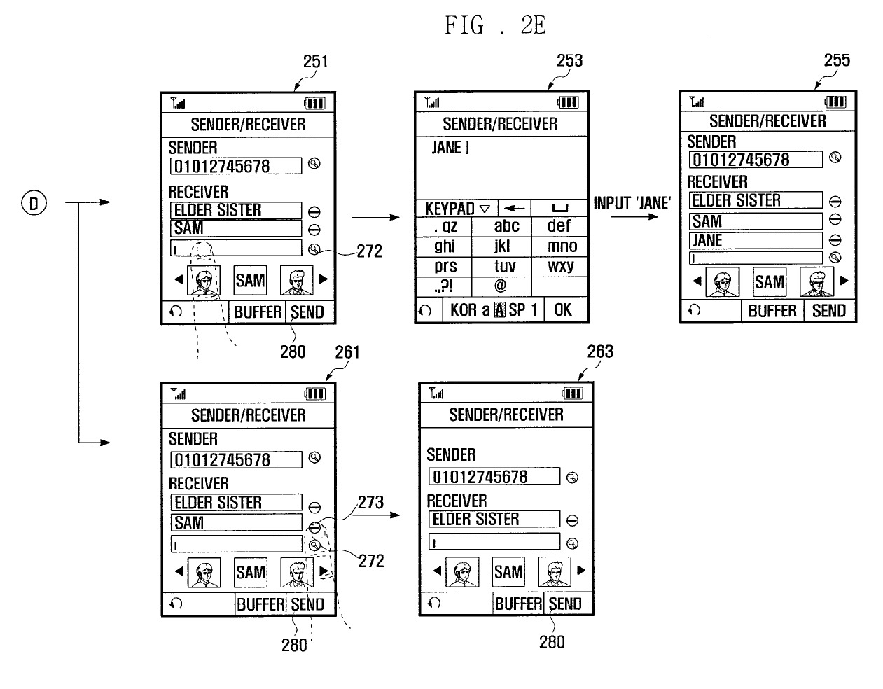

FIGS. 2A, 2B and 2C are views showing a screen that displays processes where receiver information is input in a portable terminal via a button keypad, according to an exemplary embodiment of the present invention.

Referring now to FIGS. 2A, 2B and 2C, the portable terminal activates a text message writing mode in response to a user's request, and displays a text message input window on a screen 201.

The screen 201 shows a letter input window 210 for inputting letters for a text message, a menu soft key 220 for selecting a variety of options to write a text message, a confirmation soft key 230 for progressing to the next step when letters for a text message have been input, and a letter soft key 240 for selecting types of characters for a text message. The types of characters may include the portable terminal user's native language (KOR), English lower-case letters (A), English capital letters (a), special symbols (SP), numbers (1), etc. The types of characters can be switched according to the selection of the letter soft key 240. It should be understood that the present invention is not limited to the exemplary embodiments of the screen according to a text message writing mode and the configuration of the screen as shown.

When the portable terminal user inputs letters on a screen 201, the portable terminal detects input signals according to the input letters and displays the input letters on the text message window 210 on a screen 203.

When the letters have been input on the screen 203 and then the confirmation soft key 230 is selected, the portable terminal detects an input signal of the confirmation soft key 230, and then switches the letter input window 210 into a receiver information input window on a screen 205.

The screen 205 shows a caller's information input field 250 for inputting caller's information, an item display field 260 for displaying an item that can directly call receiver information registered at a phone book, a direction soft key (for example, an arrow key) 265 for indicating that there are additionally items that are not displayed on the item field, a receiver information input field 270 for inputting receiver information, according to a selection of the item, or receiver information according to a user's inputting/searching operation, and a transmission soft key 280 for transmitting a written text message. The transmission soft key 280 appears when the receiver information input window is switched.

When the portable terminal provides the receiver information input window in response to a user's receiver information input request, the portable terminal can provide a certain number of items through the item display field 260 on the screen 205. The number of items can be determined by a user's setting. Due to the size limitation, the item display field 260 can output part of the items, which are previously set as a frequently used contact. For example, the portable terminal can display three of ten items on the item display field 260. If a highlighted mark selects the leftmost item on the item display field 260, the portable terminal user inputs a left direction key signal to move the highlighted mark, thereby selecting another item. Similarly, in a state where a highlighted mark selects the rightmost item on the item display field 260, the user inputs a right direction key signal to move the highlighted mark, thereby selecting another item. The direction soft key 265 is located at both sides of the item display field 260. The direction soft key 265 generates an item change signal for displaying other items, not displayed on the item display field 260, on the item display field 260, and outputs it to the controller. If there are not further items out of the leftmost or rightmost on the item display field 260, the corresponding direction soft key 265 is disabled and thus is displayed dimly or not displayed at all. This detailed description will be explained, in detail, later, with reference to a screen 208 and the letter input window 210.

In an exemplary embodiment of the present invention, the screen 205 (FIG. 2A) displays three items and the item display field 260 of one row. It should be, however, understood that the present invention is not limited to the example illustrated and described. For example, the screen 205 may be implemented in such a way as to display three or more items in two or more rows on the item display field 260. In the following description, an exemplary embodiment of the present invention will be explained where three items are displayed on the item display field 260.

According to a setting, the items may be provided to the item display field 260 in one of two modes. One of the two modes is a call history mode where higher ranked information, corresponding to a present number of items, is extracted from recently transmitted or received information, referring to the recent call history, and then provided to the item display field 260. The other is a designation mode where a portable terminal user directly designates particular receiver information as the frequently used information, so that the designated receiver information is provided with the item display field 260.

In a call history mode, the portable terminal searches for a call history where the recent communication is performed at a time point that the receiver information input window is provided. After that, the portable terminal extracts the recent higher ranked information from the searched call history, and then generates an item set as a link that can call receiver information corresponding to the extracted information. When the portable terminal extracts the recent higher ranked information, it may also extract information corresponding to the preset number of items from the recent higher ranked information. If the same receiver information is repeatedly shown in the list of the call history, the portable terminal preferably extracts the repeated receiver information and then the next higher ranked receiver information next to the repeated receiver information. That is, different receiver information can be extracted from the higher ranked call history, according to the preset number of the item.

The item may be provided in an icon type, but the claimed invention is not in any way limited thereto. The icon may be formed as a receiver's image registered in receiver information. If there is no image registered in receiver information, a name (or a nick name) of a receiver registered in receiver information may be used to form an icon.

The call history mode may be set as an incoming-outgoing mode, an outgoing mode, an incoming mode, or a message mode. The incoming-outgoing mode refers to a mode that searches for a call history regarding all communications that the portable terminal has recently performed and extracts higher ranked receiver information. The outgoing mode refers, for example, to a mode that searches for a call history regarding outgoing communications that the portable terminal has recently performed and extracts higher ranked receiver information. The incoming mode refers to, for example, a mode that searches for a call history regarding incoming communications that the portable terminal has recently performed and extracts higher ranked receiver information. The message mode refers to, for example, a mode that searches for a message transmission/reception record from the call history regarding communications that the portable terminal has recently performed and extracts higher ranked receiver information. It should be understood that the message mode can also be set by an incoming-outgoing mode, an outgoing mode, or an incoming mode in order to distinguish among a received-transmitted message record, a received message record, and a transmitted message record.

It is preferred that the number of receiver information, extracted in the respective modes, corresponds to the preset number of the items. That is, receiver information can be sequentially extracted from the highest rank, corresponding to the present number of the items.

With continued reference to FIG. 2A, when the portable terminal provides a receiver information input window on the screen 205, the first field of the receiver information input field 270 is initially activated (i.e., where a cursor is located) to input receiver information. It should be understood that, according to a setting, a particular item on the item display field 260 may be distinguished by a mark, such as a highlighted mark, when the receiver information input window is provided, so that the receiver information corresponding to the particular item can be displayed on the receiver information input field 270. That is, the portable terminal can display the receiver information input window on the screen 207 when the confirmation soft key 230 is selected.

Next, when the direction keys are operated on the screen 205, the activation state can be switched from, for example, the receiver information input field 270 to the item display field 260. That is, if the portable terminal detects a command for moving an activation mark from the receiver information input field 270 to the item display field 260, it activates a particular item on the item display field 260 on the screen 207 and marks the currently selected item using a highlighting method. Selecting the item can be achieved as the first item on the item display field 260 is firstly designated according to the activation mark moving command. When a corresponding item is designated and activated, it is displayed in a highlighted state, thereby being visually distinguished from others. A person of ordinary skill in the art understands and appreciates that visual distinguishment can include a variety of ways the item can be displayed versus other items.

The portable terminal may, for example, display receiver information corresponding to the selected item on the receiver information input field 270. The portable terminal may also call receiver information corresponding to the selected item from the phone book stored in the storage unit and then display it on the receiver information input field 270.

Still referring to FIG. 2A, when a particular item on the item display field 260 is designated on the screen 207, the portable terminal calls receiver information corresponding to the designated item and adaptively displays it on the receiver information input field 270 on the screen 209. That is, if the right direction key signal is input on the screen 207, the portable terminal can move the highlighted mark to the right item (Sam) on the item display field 260 on the screen 209, and then display receiver information corresponding to the highlighted item on the receiver information input field 270. In that case, the portable terminal can display the receiver information in an inactivated state (a dim color).

When a signal for moving a highlighted mark to the left is input on the screen 207 where the leftmost item is selected on the item display field 260, the portable terminal changes the items displayed on the item display field 260. The portable terminal changes items, one by one, as shown on the screen 208 (as shown in FIG. 2C, caption “C”). The portable terminal may change items (for example, three items) by a unit of screen, as shown on the screen 212. The receiver information input field 270 displays receiver information that is changed according to the movement of an item. Similarly, when the right direction key signal is input in a state where the rightmost item is highlighted, the portable terminal changes the item and displays it. If no further items exist out of the rightmost or leftmost area on the item display field 260, the corresponding direction soft key 265 is disabled and thus displayed dimly or may not be displayed at all.

After that, when a transmission soft key 280 is pressed on the display unit, the portable terminal can transmit the written text message to the called portable terminal using the receiver information that is selected as shown in screens 207 to 209. That is, the portable terminal detects the input of the transmission soft key 280 to request a transmission of the text message when receiver information is displayed in an inactivated state, i.e., before the final receiver information is input, it can transmit the text message to the called portable terminal, based on the receiver information.

When the final selection for the currently activated item is input on the item display field 260 on the screen 207 (FIG. 2A), the portable terminal inputs corresponding receiver information in the receiver information input field 270 on the screen 211. The final selection can be achieved as a number input soft key 290 is pressed on the screen 207. The number input soft key 290 is a key that may appear when a particular item is selected (highlighted) on the item display field 260 on the receiver information input window, and is used to finally input the receiver information corresponding to the selected (highlighted) item. In an embodiment of the present invention, the number input soft key 290 serves to perform a final input of receiver information on the screen 211. It should be understood by a person of ordinary skill in the art that the claimed invention is not limited to the exemplary embodiment. For example, the number input soft key 290 may also be implemented to perform a function of additionally inputting a receiver. In that case, if the number input soft key 290 is pressed, the portable terminal switches an inactivated state (e.g. a dim color) of receiver information to an activated state, displays the receiver information in an activated state, performs a final input function, generates a row to receive other receiver information, and performs a function of additionally inputting a receiver to move a cursor to the next row.

The portable terminal may display receiver information for a corresponding item, designated by a user, for example, in an inactivated state or a light color, on the screens 207 and 209. The portable terminal may also display receiver information for a corresponding item, finally input by a user, for example, in an activated state or a dark color, on the screen 211. The receiver information displayed in a light color can be changed according to the movement between items on the item display field 260. When the cursor is moved from the item display field 260 to the receiver information input field 270, the receiver information displayed in a light color may be removed from the receiver information input field 270. It should be understood by the artisan that the light or dark color could be reversed in terms or representing inactive or active states.

On the contrary, the receiver information, displayed in a dark color according to a use's final input selection, is not changed according to the movement between items on the item display field 260. The receiver information corresponding to an item, selected according to the movement between the items, may be displayed on the next row of the receiver information input field 270. For example, if receiver information of a particular item that is marked by a highlighted mark, “elder sister”, is finally input, as shown on the screens 207 and 211, and then the other item (Sam) is designated according to movement between the items as shown on the screen 213, the portable terminal retains the receiver information regarding the “elder sister” and calls receiver information regarding the other item located at the second row of the receiver information input field 270.

Meanwhile, when the highlighted mark is moved from the item display field 260 to the receiver information input field 270, the portable terminal can move the cursor not to the first row of the receiver information input field 270 to which the receiver information corresponding to the item is finally input, but can move the cursor to the second row of the receiver information input field 270. This process is shown on the screen 215 (FIG. 2B). In addition, when the highlighted mark is moved from the item display field 260 to the receiver information input field 270, the portable terminal moves the cursor to the first row of the receiver information input field 270, as shown on the screen 214 (FIG. 2B). After that, when a down direction key signal is input, the portable terminal moves the cursor to the second row of the receiver information input field 270, as shown on the screen 215. This process is intended to delete or change the final input receiver information (elder sister). That is, if the cancel key, etc., is executed in a state where the cursor is located at the first row of the receiver information input field 270, the final input receiver information can be deleted or changed from the first row.

Referring again to FIGS. 2A, 2B, and 2C when a transmission soft key 280 for requesting a transmission of a text message is input on the screen 211 (FIG. 2A) in a state where receiver information is finally input, the portable terminal can transmit a text message based on the receiver information displayed on the receiver information input field 270. If a transmission soft key 280 is pressed on the screen 213 (FIG. 2B) in a state where the finally input receiver information (elder sister) and inactivated receiver information (Sam) is displayed, the portable terminal can broadcast a text message to the receivers, “elder sister” and “Sam,” based on the receiver information.

In an exemplary embodiment of the present invention, receiver information may also be input to the portable terminal by selecting items. Receiver information may also be designated by a general searching process or a direct inputting process. These operations are shown on the screens 215 and 217 (FIG. 2B).

The portable terminal user operates the direction keys on the screen 211 or 213 (FIGS. 2A, 2B) and inputs a command for moving an activation state from the item display field 260 to the receiver information input field 270. According to the input command, the portable terminal retains the first row of the receiver information input field 270 to which receiver information of the finally input item, “elder sister,” is input, places the cursor corresponding to the movement command in the second row, and activates the receiver information input field 270. In that case, a letter soft key 240 (see screens 213, 215) for selecting types of letters may be displayed on the screen, instead of the number input soft key 290. After that, the portable terminal displays receiver information input by a user's searching process or direct inputting process, for example, “James,” on the second row of the receiver information input field 270 on the screen 217 (FIG. 2B). When the down direction key is input on the screen 217, the portable terminal may output the third row to receive new receiver information on the screen 219 and then move the cursor thereto. In an exemplary embodiment of the present invention, the size of the receiver information input field 270 is decreased on the screen 219 when receiver information is added. It should be, however, understood that the present invention is not limited to the exemplary embodiment. For example, the invention may be modified in many ways within the spirit and scope of the claimed invention, for example, such that the size of the receiver information input field is retained and instead the receiver information input field is scrolled as receiver information is added. That is, the first row is removed from the display unit, but instead the second and third rows can be output thereon.

Meanwhile, when a transmission soft key 280 for requesting a text message is input on the screen 217 (FIG. 2B) where the finally input receiver information (elder sister) and searched/directly input receiver information (James) is displayed, the portable terminal can broadcast a text message to the receivers, “elder sister” and “James,” based on the receiver information.

As described above, in an exemplary embodiment of the present invention, the receiver information can be input to the portable terminal by selecting an item. When a text message is broadcast, receiver information can be input to the portable terminal by selecting a plurality of items. Receiver information may also be input to the portable terminal by selecting an item or a user's searching process or a user's direct inputting process. In some exemplary embodiments of the present invention, receiver information is input to the portable terminal by selecting an item. After that, receiver information is input by a searching process or a direct inputting process.

It should be, however, understood that the among the many ways the present invention may be modified includes that at least piece of receiver information can be input by a searching process, or a direct inputting process, or receiver information being input by a searching process, or a direct inputting process and then by selecting an item, just to name a few possible examples of one possible type of modification within the spirit and scope of the present invention. These operations are shown on the screens 205, 221, 223, and 225. Detailed description regarding the screens 205, 221 to 225 will be omitted in the following description since they are related to the operations for inputting receiver information and have been already described above.

In the foregoing description, the method for inputting receiver information in a portable terminal using a button keypad was described. The method for inputting receiver information in a portable terminal employing a touch screen will now be explained in detail.

FIGS. 2D and 2E are views showing a touch screen that displays processes while receiver information is input in a portable terminal by a touch operation, according to an exemplary embodiment of the present invention.

Referring now to FIGS. 2D and 2E, the portable terminal activates a text message writing mode in response to a user's request and displays a text message input window on a screen 231.

In an exemplary embodiment of the present invention, the screen 231 shows a letter input window 210 for inputting letters for a text message and a confirmation soft key for progressing the next step when letters for a text message have been input. It should be understood that the present invention is not limited to the exemplary embodiment of the screen 231 according to a text message writing mode and the configuration of the screen.

When a touch event occurs on the letter input window 210 on the screen 231, the portable terminal displays a virtual keypad for allowing the portable terminal user to input letters on the screen 233. The portable terminal may display letters on the letter input window 210 on the screen 233, according to a user's input signal. The virtual keypad may input letters in a variety of input devices, such as the QWERTY keypad device, DVORAK keyboard, the Chun-Ji-In keypad device for Korean, a device for inputting italic letters, just to name a few possible non-limiting examples, etc.

When the user has input letters on the screen 233 and then taps the confirmation soft key 230, the portable terminal displays a receiver information input window on the screen 235.

Referring to FIG. 2D, the screen 235 shows a transmitter information input field 250 for inputting receiver information, an item display field 260 for displaying an item that can directly call receiver information registered at a phone book, a direction soft key 265 linked to a function for moving items that are not displayed on the item display field 260, a receiver information input field 270 for inputting receiver information according to a selection of the item or receiver information according to a user's inputting or searching process, a search menu soft key 272, located at the right side of the receiver information input field, for setting receiver information in a corresponding receiver information input field by a searching process, and a transmission soft key 280 for transmitting a written text message. The transmission soft key 280 appears when the letter input window 210 is switched to the receiver information input window.

Still referring to at least FIG. 2D, the item display field 260 can output part of the previously set items due to the size limitation of the display unit. For example, with reference to screen 235, the portable terminal can display three of then items on the item display field 260. The portable terminal user taps one of the direction soft keys 265, located at the right and left of the item display field 260, to change an item displayed on the item display field 260. In an exemplary embodiment of the present invention, the screen 235 displays three items aligned in one row on the item display field 260. It should be, however, understood that the present invention is not limited to the exemplary embodiment. For example, the screen 235 may display, for example, a plurality of items in two or more rows on the item display field 260. In the following description, the exemplary embodiment of the present invention will be explained where three items are displayed on the item display field 260. Basically, the invention contemplates any number of rows/columns technically feasible, with a general preference for ease of use and explanation to the number of rows/columns shown in the examples provided herein.

Still referring to FIG. 2D, when the user taps the direction soft key 265 located on the right or left on the screen, the portable terminal can change an item displayed on the item display field 260. That is, the portable terminal moves the items, one by one, on the screen 243 or items by a unit of screen (for example, three items) on the item display field 260 on the screen 245. Simultaneously, the receiver information input field 270 changes receiver information in response to the item movement and displays the changed receiver information. The screens 241, 243 and 245 display a case where the user taps the direction soft key 265 located at the left thereof. Meanwhile, if any other further item does not exist in the most right or left direction, a corresponding direction soft key 265 is disabled (inactivated) or not displayed.

As described in the above exemplary embodiment of the present invention, the user interface is implemented to move or change one item or items in a screen unit on the item display field 260. For example, the user interface may also be, for example, implemented in such that the item display field 260 displays a currently selected item on its center portion in an enlarged size and items both at the right and left sides of the currently selected item in a smaller size than that of the currently selected item, as just one possible example of the many ways the invention can be implemented. This user interface allows the preceding (right or left), current (center) and following (left or right) items to be rotated as the user taps the direction soft key 265, so that the item at the center can be switched with the preceding or following item.

With continued reference to FIG. 2D, when the user taps a particular item on the screen 235, the portable terminal displays receiver information corresponding to the touched item on the receiver information input field 270. To this end, the portable terminal calls receiver information corresponding to the selected item from a phone book that is previously registered in the storage unit. An example of this process is shown on the screen 237. That is, when a user touches an item “Elder sister” on the item display field 260 on the screen 237, the item “Elder sister” is displayed on the first row of the receiver information input filed 270, which is hereinafter called the first receiver information input field. After receiving the receiver information, the portable terminal generates and outputs the second row for receiving another receiver information (hereinafter called the second receiver information input field) in the receiver information input field 270. In that case, a search menu soft key 272, located at the right side of the first receiver information input field, for activating a search menu is changed to a delete menu soft key 273 for deleting receiver information from the first receiver information input field. This will be explained in detail, herein after, referring to the screens 261 and 263 in FIG. 2E.

With reference to FIGS. 2D and 2E, when the user taps other items in the item display field 260 on the screen 237 (FIG. 2D), the portable terminal calls receiver information corresponding to the tapped item and displays it in the second receiver information input field on the screen 239. Simultaneously, the portable terminal generates the third row for receiving other receiver information (hereinafter called the third receiver information input field) on the screen 239. As such, if the portable terminal is to transmit a text message to a plurality of receivers, it can add input fields to the receiver information input field 270 in the row direction. If the portable terminal cannot display all receivers on the receiver information input field, once, it may move the higher positioned receiver information in the top direction so that it cannot be displayed on the screen. In this process, the higher positioned receiver information is not removed from the portable terminal, but just disappears from being viewed on the screen.

In an exemplary embodiment of the present invention, receiver information can be input to the portable terminal by selecting an item. Receiver information may also be designated by a searching process or a direct inputting process. This is shown on the screens 251 to 253 (FIG. 2E). That is, when a user touches the third receiver information input field on the screens 239 and 251, the portable terminal displays a virtual keypad on the screen 253, so that the user can directly input receiver information through the virtual keypad. After that, the user inputs receiver information, input through the virtual keypad, for example, “JANE” in the third receiver information input field on the screen 255. The portable terminal further outputs the fourth row for receiving new receiver information on the receiver information input field 270 and then locates the cursor in the fourth row. Although it is not shown in FIGS. 2D and 2E, receiver information may be added to the portable terminal through a searching process that is performed by touching the search menu soft key 272 located at the right side of the receiver information input field 270. That is, the user searches for a call record or a message transmission/reception record by touching the search menu soft key 272 and then inputs receiver information to the portable terminal. On the other hand, when a user touches the delete menu soft key 273 displayed on the right side of the second receiver information input field on the screens 239 and 261, the portable terminal deletes receiver information input in the second receiver information input field and displays only one piece of receiver information on the screen 263. When a user has performed a setting for receivers using a variety of methods described above and then tapped a transmission soft key 280, the portable terminal can transmit the written text message to at least one of the receivers input in the receiver information input field 270.

Although some of the exemplary embodiments of the present invention are implemented such that receiver information is input to the portable terminal by touching the items, Applicant reiterates that it should be understood that the present invention is not limited to any depiction/descriptions of the examples provided herein. For example, receiver information may be input to the portable terminal in such a way that a particular item located in the item display field is dragged and dropped to the receiver information input field. A plurality of pieces of receiver information may also be input to the portable terminal, once, by simultaneously touching a plurality of items. Furthermore, if the item display field is configured with a plurality of rows and columns and a user forms a closed curve thereon, the items within the closed curve can be input to the receiver information input field 270.

In the foregoing description, methods have been explained that input receiver information in the portable terminal, using items, when a user writes a text message. In the following description, the control operations of the receiver information inputting apparatus according to an exemplary embodiment of the present invention are explained in more detail.

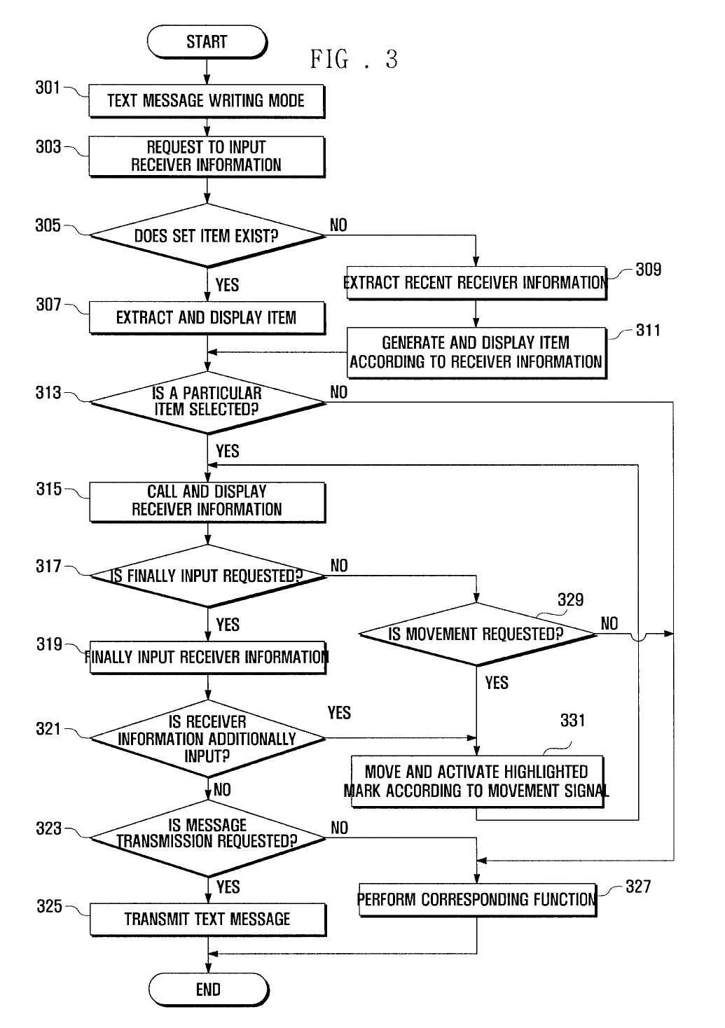

FIG. 3 is a flow chart providing exemplary operational steps for a method for inputting receiver information of a text message in a portable terminal according to an exemplary embodiment of the present invention.

Referring now to FIG. 3, the portable terminal provides a text message writing mode in response to a user's request (301). When the user has written a text message, he/she inputs information regarding a receiver, who will receive the written text message, in the portable terminal.

When the portable terminal detects a user's request to input receiver information in the text message writing mode (303), it provides a receiver information input window for inputting receiver information. The portable terminal identifies a setting mode according to a method for displaying items (305). That is, the portable terminal determines whether there is an item previously set by the user.

If the portable terminal ascertains that there is an item previously set by the user at 305, i.e., the setting mode is a designating mode, it extracts and displays the previously set item on an item display field (307). On the contrary, if the portable terminal ascertains that there is not an item previously set by the user at 305, i.e., the setting mode is a call history mode, it searches a call history and extracts recent receiver information (309). After that, the portable terminal generates items according to the extracted receiver information and displays part of the generated items on the item display field (311).

Still referring to FIG. 3, after displaying items according to the setting modes, the portable terminal identifies a user's receiver information input (313). That is, the portable terminal checks whether or not the user selects a particular item.

If the portable terminal detects a selection of a particular item at 313, it calls receiver information regarding the selected item and then displays it on the receiver information input field (315). After that, the portable terminal determines whether there is a final input request for receiver information displayed on the receiver information input field (317).

If the portable terminal ascertains that there is a final input request for receiver information regarding the selected item at 317, it finally inputs the receiver information in the receiver information input field (319). On the contrary, if the portable terminal ascertains that there is not a final input request at 317, it determines whether there is a request for moving a highlight from the particular item to the other items (329). If the portable terminal detects a request for moving a highlight from the particular item to other items at 329, it moves a highlight from the particular item to the other item and highlights the other item (331). After that, the portable terminal calls receiver information corresponding to the other item, and displays the called receiver information on the receiver information input field at 315.

Next, after performing the finally inputreceiver information at 319, the portable terminal checks whether other receiver information is additionally input (321). If the portable terminal ascertains that other receiver information is additionally input at 321, it proceeds with step 331 and performs a procedure of inputting receiver information according to a selection of an item, as described above. In that case, the portable terminal moves the cursor to the next row in the receiver information input field to input additional receiver information and then displays it.

If the portable terminal ascertains that other receiver information is not additionally input at 321, i.e., the receiver information has been input, it determines whether a transmission of the written text message is requested (323). If the portable terminal ascertains that a transmission of the written text message is requested at 323, it transmits the written text message to the receiver based on at least one piece of receiver information (325). In an exemplary embodiment of the present invention, the text message may be transmitted according to one piece of receiver information or broadcast according to a plurality of pieces of receiver information.

On the contrary, if the portable terminal does not detect a selection of a particular item at 313, a corresponding operation is performed according to a user's request (327). The corresponding operation includes an operation where a user directly inputs receiver information or an operation where receiver information is input according to a phone book searching process.

Meanwhile, if the portable terminal ascertains that a transmission of the written text message is not requested at 323, it performs a corresponding operation according to a user's request at 327. The corresponding operation includes editing a text message, terminating writing a text message, temporarily storing a text message, a variety of option settings for a text message transmission.

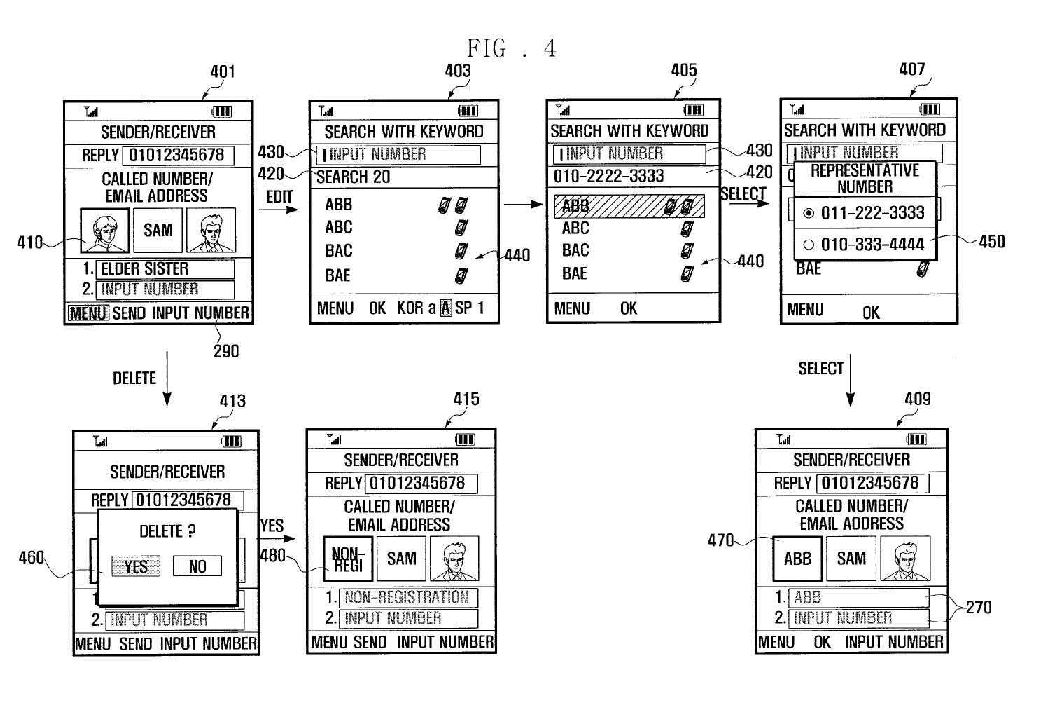

In the foregoing description, an example of a method for inputting receiver information to transmit a text message in a portable terminal according to the present invention has been explained. In the following description, a method for registering an item to input receiver information is now explained in detail with reference to FIG. 4.

FIG. 4 is views showing a screen that displays processes while an item is set, according to an exemplary embodiment of the present invention.

Referring now to FIG. 4, this exemplary embodiment of the present invention is explained based on a process where a particular item is edited in a text message writing mode. It should be understood that that the present invention is not limited to the embodiment. For example, the exemplary embodiment may be modified in such that an item edit mode is performed through a menu executing procedure and then items are edited. It will be appreciated that there are many other modifications based on the exemplary embodiment of FIG. 4.

Similar to the exemplary embodiments of FIGS. 1 to 3, the portable terminal in this example can provide a receiver information input window on the screen 401 during the text message writing mode.

A portable terminal user can edit a currently highlighted item 410 on the screen 401 using a menu soft key, etc. The portable terminal sets the currently highlighted item 410 in an edit state in response to a user' item edit request, and displays a phone book list for editing the item 410 on the screen 403.

The portable terminal displays a phone book list on the screen 403, in response to a user's request. The screen 403 may be variously implemented according to any particular type of portable terminal being used. The screen 403 shows an information field 420 for indicating the number of receiver information contained in the total list of phone books and a representative phone number of corresponding receiver information when the receiver information is highlighted, a search field 430 for searching for particular receiver information from the phone book list, and an item field 440 for displaying respective items of receiver information in the phone book list.

Next, the user can select a particular receiver item (ABB) from the phone book list on the screen 403, by operating direction keys or according to a touch event. The user can directly select the particular receiver item (ABB) by operating direction keys or touching an area corresponding to the particular receiver item (ABB) on the screen 403. The user can also select the particular receiver item (ABB) by performing a searching process with respect to the search field 430.

As shown on the screen 405, the portable terminal highlights the selected receiver item (ABB) and displays a representative phone number of the receiver item (ABB) on the information field 420. In an exemplary embodiment of the present invention, it is assumed that the receiver item (ABB) contains two or more phone numbers.

When the portable terminal ascertains that the user has selected the highlighted receiver item (ABB) on the screen 405, by a confirmation soft key or a touch, it can identify information set in the receiver item (ABB). The information may contain at least one phone number corresponding to the receiver item, an email address of the receiver, etc. If the set information has two or more phone numbers or a combination of a phone number and an email address, the portable terminal outputs a pop-up window 450 of at least two or more pieces of information on the screen 407, so as to provide the user with an option. The pop-up window 450 contains information regarding a receiver corresponding to the item, and also provides a user with an option for selecting one of the information (as representative information). If one phone number is set in the receiver item (ABB), the portable terminal may skip the process shown in screen 407.

When the user can select a particular phone number on the screen 407, the portable terminal designates the selected phone number as a representative number for an item and then checks whether there is information regarding an image set in the receiver item.

If the portable terminal ascertains that image information exists, it matches the image information with the representative number, and then sets it as an item. On the contrary, if image information does not exist, the portable terminal matches the receiver's name (or nickname), set in the receiver item (ABB), with the representative number and then sets it as an item. This process is shown on the screen 409.

Still referring to FIG. 4, as shown on the screen 409, the item 410 on the screen 401 is changed to an item 470 while it is processed through the setting procedure described above. Since the portable terminal was in a text message writing mode before the edit process, the portable terminal provides a receiver information input window, highlights the edited item 470, and displays the receiver information set in the item 470 on the receiver information input field 270.

When the user deletes a currently highlighted item 410 on the screen 401 by using a menu soft key, the portable terminal can output a pop-up window 460 inquiring whether the currently highlighted item 410 is deleted on the screen 413. If the user selects ‘Yes’ on the pop-up window 460, the portable terminal deletes the highlighted item 410. In that case, the portable terminal changes the item 410 into a non-registered item 480 and displays it on the screen 415. Afterwards, the user may register other items at the non-registered item 480 using a menu soft key, etc.

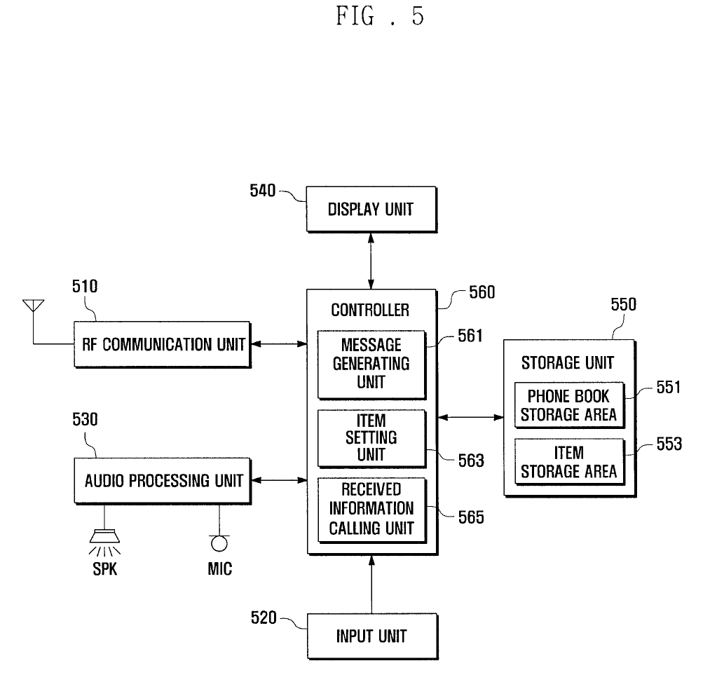

In the exemplary embodiments of the present invention, although a portable terminal in the examples was used, the claimed invention can be applied to all types of information communication devices, multimedia devices, and their applications, which can transmit text message to the other devices. Examples of the portable terminal are a mobile communication terminal, a personal digital assistant (PDA), a portable multimedia player (PMP), an MP3 player, a digital broadcast player, a personal computer, a laptop computer, etc. The configuration and operation of the portable terminal is described in detail with reference to FIG. 5.

FIG. 5 is a schematic block diagram illustrating a portable terminal according to an exemplary embodiment of the present invention.

Referring now to FIG. 5, the portable terminal includes an RF communication unit 510, an input unit 520, an audio processing unit 530, a display unit 540, a storage unit 550, and a controller 560. The storage unit 550 includes a phone book storage area 551 and an item storage area 553. The controller 560 includes a message generating unit 561, an item setting unit 563, and a received information calling unit 565.

The RF communication unit 510 allows the portable terminal to communicate with other portable terminals. It establishes a communication channel with an RF network system (including a base station) and performs voice communication and data communication therethrough. It is configured to include an RF transmitter for up-converting the frequency of transmitted signals and amplifying the transmitted signals and an RF receiver for low-noise amplifying received RF signals and down-converting the frequency of the received RF signals. In particular, the RF communication unit 510 transmits/receives text messages to/from the other portable terminals according to the control of the controller 560. When receiver information according to the selection of an item has been input in the portable terminal and then a transmission of a text message is requested, the RF communication unit 510 transmits the text message to the receiver corresponding to the receiver information in the receiver information input field, according to the control of the controller 560.

The input unit 520 receives a variety of letter information. It also receives signals for setting and controlling a variety of functions in the portable terminal and outputs them to the controller 560. The input unit 520 may be implemented to further include a separate touch pad or implemented with a touch pad, according to the types of portable terminals. It may also be formed by one of a variety of input means including than some of the examples previously shown and described, such as, a touch pad, a touch screen, a keypad, a QWERTY keypad, Dvorak keypad, or by a combination thereof just to name a few possible examples. In particular, the input unit 520 receives input signals for inputting receiver information and input signals according to the selection of an item and outputs them to the controller 560.

The audio processing unit 530 reproduces audio signals via a speaker SPK. It also receives audio signal from a microphone MIC and outputs them to the controller 560. That is, the audio processing unit 530 converts audio signals into audible sound signals and then outputs them via the speaker SPK. It also receives audio signals, such as voice sound, etc., via the microphone MIC, generates digital data, and then outputs such signals to the controller 560. For example, the audio processing unit 530 converts analog voice signals from the microphone MIC into digital voice signals and outputs them to the controller 560. the audio processing Unit 530 may also converts the digital voice signals into analog voice signals and outputs them via the speaker SPK.

The display unit 540 displays data generated when the portable terminal is operated, user's input events, state information, such as, the operation states and key operating states of the portable terminal, setting information regarding functions of the portable terminal, etc. The display unit 540 displays input windows and screen data, related to screens for writing a text message according to the control of the controller 560. The display unit 540 displays signals and color information, output from the controller 560. The operations and screens of the display unit 540 are illustrated in FIGS. 1 to 4. In particular, the display unit 540 displays a receiver information input window when the portable terminal is operated in a text message writing mode. The receiver information input window includes an item display field containing a certain number of items and a receiver information input field for receiving receiver information. The display unit 540 displays an area for outputting the item display field, hereinafter called an item display field area, and an area for outputting the receiver information input field, hereinafter called a receiver information input field area. When the display unit 540 receives an item change signal for allowing the other item, which is not shown on the item display field area, to be displayed, at least one of the displayed items can be changed to the other item and then displayed. For example, if the display unit 540 receives an item change signal for changing the item on the left, it removes the rightmost item from the screen and moves the other items right. When an empty space is formed at the leftmost area sine the items are moved right, it is filled and displayed with the other item that was not shown before. It should be understood that the present invention is not in any way limited to the exemplary embodiment where one item is changed when the item change signal is input. For example, the exemplary embodiment may be modified such that a plurality of items, for example, all items currently output on the item display field, can be changed into items not shown on the screen when the item change signal is input, just to name one possible example within the spirit and scope of the claimed invention.

If the display unit 540 receives a plurality of pieces of receiver information and cannot display all of them on the receiver information input field area, it removes the oldest or highest receiver information from the receiver information input field area and then moves the remaining receiver information in the top direction, so that the latest input receiver information can be displayed on the lowest portion in the receiver information input field area. The lowest portion is generated as the remaining receiver information is moved in the top direction. The oldest or highest receiver information, removed from the screen, just disappears from the screen but is not deleted from the portable terminal.

The display unit 540 may be implemented with any type of screen technology available or that will become available, but preferably a thin screen technology, which can include a liquid crystal display (LCD). In that case, it includes an LCD controlling unit, a memory for storing image data, and an LCD device. The display unit 540 may also be implemented with a touch screen. The touch screen is configured to include a touch panel (not shown). The touch panel may be applied to the front of the display unit 540. If the display unit 540 is implemented with a touch screen, it can also serve as an input device. The touch screen detects changes in the physical quantity due to a user's touch and outputs a touch signal corresponding to the physical quantity change to the controller 560. Touch screens may be implemented with a variety of types, such as a pressure sensor, resistive/pressure sensitive, resistive, capacitive, ultrasonic reflective, optical sensor, electronically inductive, etc. Since the operational principles of the touch screens are well-known, it will not be explained in this application.

The storage unit 550 is configured to include, for example, read only memories (ROMs), read access memories (RAMs), etc. The storage unit 550 stores a variety of data generated and used from and by the portable terminal. The variety of data includes data generated when application programs are executed in the portable terminal, and all types of data that is generated in the portable terminal or received from the external system. In particular, the data also includes text messages that will be transmitted or are received, phone books, and items. Furthermore, the data includes a variety of information for setting the user interface and the functions of the portable terminal.

The storage unit 550 can store setting information related to the input of receiver information according to the selection of items that are adapted to the present invention. This setting information is provided through the item display field. The setting information may be the number of total items that will be registered in the item display field, as a frequently used contact, the number of items in the item display field, which can be displayed on one screen, image information regarding respective items registered in the item display field, receiver information corresponding to the respective items, information for setting a method for extracting items that will be displayed on the item display field, etc. The setting information related to the input of receiver information is stored in the item display storage are 553. The storage unit 550 stores a phone book containing at least one phone number registered by the user. The phone book is stored in the phone book storage area 551.

The storage unit 550 stores application programs for controlling the operations of the portable terminal and the processes for inputting receiver information according to the selection of items. These application programs are processed in the portable terminal as shown in FIGS. 1 to 5. The application programs are stored in an application program storage area (not shown) of the storage unit 550.

The storage unit 550 includes at least one or more buffers for temporarily storing data generated when the application programs are executed. The storage unit 550 may be configured within the portable terminal. The storage unit 550 may further include a smart card as an external memory device. It should be understood that the storage unit 550 according to an exemplary embodiment of the present invention preferably includes all internal/external storage media.

The controller 560 controls the entire operation of the portable terminal. It also controls the flow of signals among blocks in the portable terminal, such as the RF communication unit 510, the input unit 520, the audio processing unit 530, the display unit 540, the storage unit 550, etc. The controller 560 may further include a data processor comprised of a codec and at least one modem, which are operated to provide mobile communication services.

In an exemplary embodiment of the present invention, the controller 560 displays an item display field and a receiver information input field on the receiver information input window. The controller 560 provides a preset number of items through the item display field, and controls the input of receiver information according to the selection of items. The controller 560 can provide the items by extracting receiver information from a call history, according to the settings or by extracting previously set receiver information. The controller 560 calls receiver information linked to respective items in the item display field, in response to a user's request, and controls how the called receiver information is displayed on the receiver information input field. The controller 560 also controls a series of operations related to the method for setting and editing the respective items in the item display field.

The controller 560 controls the operations of the portable terminal as explained in the description of FIGS. 1 to 4. It should be understood that the function controls of the controller 560 can be implemented by an application program comprising machine executable code stored on a machine a readable medium that is executed by a processor or microprocessor. In the following description, the control operations of the controller 560 are explained in detail.

As described above, the controller 560 includes a message generating unit 561, an item setting unit 563, and a received information calling unit 565.

The message generating unit 561 processes a series of operations for generating text messages in the portable terminal. When the portable terminal receives a text message from the other portable terminal, the message generating unit 561 displays the text message on the display unit 540 in response to a user's request. The message generating unit 561 allows a user to write a text message in the portable terminal. The message generating unit 561 generates a text message according to input signals that the user inputs in the text message writing mode and then transmits the written text message according to the input receiver information.

The received information calling unit 565 extracts items and displays the extracted items on the item display field, in response to a user's request to input receiver information.

When a particular item is selected from the item display field, the received information calling unit 565 calls corresponding receiver information linked to the selected item from a phone book, and then displays the called receiver information on the receiver information input field. When a highlighted mark is moved between items on the item display field, the received information calling unit 565 adaptively calls and displays receiver information corresponding to the highlighted item. The received information calling unit 565 finally inputs the receiver information in the receiver information input field, in response to the final input request for receiver information, and then activates the next input field.

The item setting unit 563 provides a phone book list, in response to a request to edit an item located at a particular position in the item display field, and replaces the item located at the particular position, based on the receiver information that is selected from the phone book list. The item setting unit 563 may also perform a deleting or registering process with respect to an item located at a particular position in the item display field. If image information corresponding to the receiver information exists, the item setting unit 563 matches the image information with a phone number according to the receiver information and processes a setting for a corresponding item. On the contrary, if image information corresponding to the receiver information does not exist, the item setting unit 563 matches a receiver's name (or a nickname) set in the receiver information with a phone number according to the receiver information and process a setting for a corresponding item.

Although the exemplary embodiment according to the portable terminal shown in FIG. 5 schematically illustrates elements to illustrate certain exemplary aspects of the present invention, it should be, however, understood that the present invention is not limited to the exemplary embodiment.

For example, the portable terminal according to the present invention may further include a digital broadcasting module, a short-range communication module, an Internet communication module, a camera module, etc. It will be easily appreciated that the embodiment according to the portable terminal of the present invention may be modified in such a way that part of the blocks described above are removed or replaced with other blocks.

In addition, the portable terminal, for example, may be configured to include a short-range communication module to support short-range wireless communication, such as Bluetooth or Zigbee communication, etc. In that case, the short-range communication module can be communicated with other portable terminals, via short-range wireless communication, according to the control of the controller 560. The portable terminal may also be configured to include an Internet module to support Internet communication via an Internet network. In that case, the Internet module can be wirelessly communicated with other portable terminals via the Internet network, according to the control of the controller 560. Furthermore, the portable terminal may include a broadcast reception module to provide digital broadcasting services.

As described above, an exemplary embodiment of the present invention selects an item by calling a representative phone number set to the item and displaying it on the receiver information input field. However, if there were a plurality of pieces of information (a combination of phone numbers and email addresses) corresponding to an item, one piece of receiver information is selected and then displayed via a pop-up window. That is, the pop-up window shows a plurality of pieces of information regarding a receiver corresponding to the item, and thus allows a user to select one of them.

As described above, the method and apparatus according to the present invention can more intuitively and easily input receiver information of a text message in a portable terminal in order to transmit the text message to the other portable terminals. In order to transmit a text message, a portable terminal user can conveniently input frequently used receiver information in the portable terminal by selecting an item on the receiver information input window, without an additional searching or selecting process. When a portable terminal user transmits a text message, he/she can conveniently input receiver information according to a recent call history in the portable terminal by selecting an item on the receiver information input window, without an additional searching or selecting process. That is, the method and apparatus according to the present invention allows the portable terminal user to intuitively select an item and input corresponding receiver information in the protection area, thereby enhancing a user convenience by providing the input of receiver information for a text message.

It will be appreciated that the method and apparatus according to the present invention can be applied to all area that requires a process of inputting receiver information, such as data transmission, as well as text message transmission. Therefore, while a portable terminal searched for other portable terminals via short-range wireless communication and establishes connection with the searched portable terminal, information regarding the other portable terminal is provided to the item, so that connection with a particular portable terminal can be easily established according to the selection of the item.

Although the invention has been shown and described with respect to exemplary embodiments thereof, it should be understood that these embodiments are only illustrative and not intended to limit the scope of the invention. Therefore, one skilled in the art will understand that the embodiments disclosed in the description and configurations illustrated in the drawings are only preferred exemplary embodiments, instead there may be various modifications, alterations, and equivalents thereof, without departing from the scope and sprit of the invention as described in the accompanying claims.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

What is claimed is:

1. A method for inputting receiver information when a text message is transmitted, comprising:
extracting and displaying a preset number of items in response to a request to input receiver information;
calling receiver information linked to an item that is selected from among the items; and
inputting the called receiver information in a receiver information input field.

2. The method of claim 1, wherein the selected item serves to call receiver information linked to a corresponding item from a phone book, and automatically inputs the called receiver information in the receiver information input field.

3. The method of claim 2, wherein extracting and displaying the preset number of items comprises:
determining an item extracting method in response to the request to input receiver information;
searching information regarding call history in response to the item extracting method;
extracting a preset number of pieces of information that are located in a higher position in a call history; and
extracting and displaying the items linked to functions for call receiver information corresponding to the extracted information.

4. The method of claim 3, wherein extracting and displaying the preset number of items comprises extracting and displaying items having a number previously registered and preset, in respect to the item extracting method.

5. The method of claim 1, wherein extracting and displaying the preset number of items comprises:
displaying at least a part of the extracted items on a item display field; and
changing, in response to an item changing signal for selecting other items not output on the item display field, at least one of the displayed items to any one of the other items.

6. The method of claim 1, further comprising:
finally inputting the receiver information to the receiver information input field.

7. The method of claim 6, wherein finally inputting the receiver information comprises:
adding a receiver information input field for inputting other receiver information.

8. The method of claim 6, further comprising:
changing receiver information in the receiver information input field into receiver information corresponding to another selected item, if the selected item is changed before the process of finally inputting the receiver information.

9. The method of claim 8, further comprising:
adaptively calling receiver information linked to the changed item in response to the change in the selected item, and reflecting the called receiver information to the receiver information input field.

10. The method of claim 6, wherein the receiver input information field comprises at least a first row and a second row, and said method further comprising:
retaining receiver information in the receiver information input field, and inputting the changed item in the second row of the receiver information input field, if the selected item is changed after the process of finally inputting the receiver information.

11. The method of claim 10, further comprising:
adaptively calling receiver information linked to the changed item in response to the change in the selected item, and reflecting the called receiver information to the second row in the receiver information input field.

12. The method of claim 1, further comprising:
transmitting the text message based on at least one of the receiver information input to the receiver information input field, when transmission of a text message is requested after receiver information according to the selected item has been input.

13. The method of claim 1, further comprising:
setting the image information as an icon corresponding to the item, when image information corresponding to corresponding receiver information exists; and
setting the image information as an icon corresponding to the item using name information registered at the receiver information, when image information corresponding to corresponding receiver information does not exist.

14. A portable terminal comprising:
a display unit for displaying a screen according to a text message writing mode and a receiver information input window, wherein the receiver information input window comprises an item display field of a predetermined number of items and a receiver information input field;
a storage unit for storing setting information related to input receiver information according to an item selection, and for storing a phone book containing at least one phone number previously registered; and
a controller for calling receiver information from the phonebook that corresponds to an item selected from among the predetermined number of items in the item display field, and for inputting the called receiver information in the receiver information input window.

15. The portable terminal of claim 14, wherein the setting information comprises:
a total number of items that will be registered on the item display field;
a quantity of items that will be displayed on one screen of the item display field;
image information regarding respective items that are registered on the item display field;
receiver information corresponding to said respective items registered on the item display field; and
setting information regarding a method for extracting an item that will be displayed on the item display field.

16. The portable terminal of claim 14, wherein the display unit displays part of the predetermined number of items on the item display field, and a direction soft key on its side, in which the direction soft key generates an item change signal to display other items that are not displayed on the item display field.

17. The portable terminal of claim 16, wherein the display unit displays at least one changed item on the item display field according to the item change signal.

18. The portable terminal of claim 14, wherein the controller distinguishes between the item display field and the receiver information input field when the receiver information input window is requested, extracts a preset number of items, and displays the items on the item display field.

19. The portable terminal of claim 18, wherein the controller:
extracts receiver information of a call history to provide an item to the item display field, according to a preset method; or
provides an item to the item display field by extracting previously set receiver information.

20. The portable terminal of claim 19, wherein the controller comprises:
a received information calling unit for calling corresponding receiver information linked to a particular item that is selected on the item display field from the phone book, and for inputting the called receiver information in the receiver information input field; and
an item setting unit for providing a phone book list in response to a request to edit an item located at a particular position on the item display field, and for replacing the item located at a particular position with an item of receiver information selected from the phone book list.

21. The portable terminal of claim 20, wherein:
the received information calling unit adaptively calls receiver information corresponding to a highlighted item, displays the receiver information on the item display field, finally inputs the receiver information in the receiver information input field, and adds a receiver information input field to input next receiver information; and
the highlighted item is designated as the highlight is moved from one item to another item on the item display field.

22. The portable terminal of claim 20, wherein the item setting unit processes a setting regarding a corresponding item by:
matching the image information with representative information according to the receiver information if image information corresponding to the receiver information exists; and
matching a receiver name set in the receiver information with representative information according to the receiver information if image information corresponding to the receiver information does not exist.

23. The portable terminal of claim 14, further comprising:
an RF communication unit for processing transmission of the text message according to the receiver information in the receiver information input field when the receiver information according to the selected item is input and a transmission of the text message is requested.

24. The portable terminal of claim 14, further comprising:
an input unit, wherein the input unit comprises at least one of a button keypad, touch pad, and touch panel.
